(19) United States
(12) Patent Application Publication
(10) Pub. No.: US 2026/0332299 A1
(43) Pub. Date: Oct. 22, 2026

(54) DECODING DOWNLINK CONTROL INFORMATION (DCI) BASED AT LEAST IN PART ON DECODING PATH METRICS

(71) Applicant: Lenovo (United States) Inc., Morrisville, NC (US)

(72) Inventors: Abir Ben Hadj Fredj, Wiesbaden (DE); Razvan-Andrei Stoica, Essen (DE)

(73) Assignee: Lenovo (United States) Inc., Morrisville, NC (US)

(21) Appl. No.: 19/429,982

(22) Filed: Dec. 22, 2025

(51) Int. Cl. H04L 1/00; H04W 72/232

(52) U.S. Cl. CPC H04L 1/0061; H04W 72/232

(57) ABSTRACT

Various aspects of the present disclosure relate to decoding downlink control information (DCI) based at least in part on decoding path metrics. An apparatus, such as a UE, receives a DCI polar codeword comprising cyclic redundancy check (CRC) bits distributed at different checkpoints of the received DCI polar codeword. The apparatus decodes at least a portion of the DCI polar codeword to generate multiple decoding paths and one or more path metrics for the decoding paths and performs one or more CRC checks at one or more checkpoints of the decoding paths, wherein the one or more checkpoints comprise one or more CRC parity bits. The apparatus updates one or more of the path metrics for one or more of the decoding paths based at least in part on an outcome of the one or more CRC checks.

### TECHNICAL FIELD

The present disclosure relates to wireless communications, and more specifically to downlink control information (DCI) encoding and decoding in wireless communications.

### BACKGROUND

A wireless communications system may include one or multiple network communication devices, which may be otherwise known as network equipment (NE), supporting wireless communications for one or multiple user communication devices, which may be otherwise known as user equipment (UE), or other suitable terminology. The wireless communications system may support wireless communications with one or multiple user communication devices by utilizing resources of the wireless communication system (e.g., time resources (e.g., symbols, slots, subframes, frames, or the like) or frequency resources (e.g., subcarriers, carriers, or the like)). Additionally, the wireless communications system may support wireless communications across various radio access technologies including third generation (3G) radio access technology, fourth generation (4G) radio access technology, fifth generation (5G) radio access technology, among other suitable radio access technologies beyond 5G (e.g., sixth generation (6G)).

### SUMMARY

As used herein, including in the claims, an article “a” before an element is unrestricted and understood to refer to “at least one” of those elements or “one or more” of those elements. The terms “a,” “at least one,” “one or more,” and “at least one of one or more” may be interchangeable. As used herein, including in the claims, “or” as used in a list of items (e.g., a list of items prefaced by a phrase such as “at least one of” or “one or more of” or “one or both of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on”. Further, as used herein, including in the claims, a “set” may include one or more elements.

The devices (e.g., NE, UE), processors, and methods of the present disclosure each have several innovative aspects, no single one of which is solely responsible for the desirable features disclosed herein.

A UE for wireless communication is described. The UE may be configured to, capable of, or operable to perform one or more operations as described herein. For example, the UE may be configured to, capable of, or operable to receive a DCI polar codeword including cyclic redundancy check (CRC) bits distributed at different checkpoints of the received DCI polar codeword; decode at least a portion of the DCI polar codeword to generate multiple decoding paths and one or more path metrics for the decoding paths; perform one or more CRC checks at one or more checkpoints of the decoding paths, wherein the one or more checkpoints include one or more CRC parity bits; and update one or more of the path metrics for one or more of the decoding paths based at least in part on an outcome of the one or more CRC checks.

A processor (e.g., a standalone processor chipset, or a component of a UE) for wireless communication is described. The processor may be configured to, capable of, or operable to perform one or more operations as described herein. For example, the processor may be configured to, capable of, or operable to receive a DCI polar codeword including CRC bits distributed at different checkpoints of the received DCI polar codeword; decode at least a portion of the DCI polar codeword to generate multiple decoding paths and one or more path metrics for the decoding paths; perform one or more CRC checks at one or more checkpoints of the decoding paths, wherein the one or more checkpoints include one or more CRC parity bits; and update one or more of the path metrics for one or more of the decoding paths based at least in part on an outcome of the one or more CRC checks.

A method performed or performable by a UE for wireless communication is described. The method may include receiving a DCI polar codeword including CRC bits distributed at different checkpoints of the received DCI polar codeword; decoding at least a portion of the DCI polar codeword to generate multiple decoding paths and one or more path metrics for the decoding paths; performing one or more CRC checks at one or more checkpoints of the decoding paths, wherein the one or more checkpoints include one or more CRC parity bits; and updating one or more of the path metrics for one or more of the decoding paths based at least in part on an outcome of the one or more CRC checks.

In some implementations of the UE, the processor, and the method described herein, the DCI polar codeword is decoded using one or more sequential list decoders, and wherein the one or more path metrics are updated between frozen bits and information bits of the one or more decoding paths; the sequential list decoder includes one or more of a successive cancellation list (SCL), a simplified successive cancellation list (SSCL), or a pruning successive cancellation list (PSCL); the at least one processor is operable to cause the UE to: trigger early termination of decoding of the DCI polar codeword based at least in part on a one or more path metrics meeting a threshold; the UE includes a decoder operable to perform the early termination of decoding of the DCI polar codeword; the at least one processor is operable to cause the UE to: continue the decoding of the DCI polar codeword based at least in part on one or more path metrics being below the threshold; the threshold is determined based at least in part on a universal polar reliability sequence and is independent of channel condition and code rate; the one or more path metrics indicate a reliability of respective individual decoding paths; the one or more path metrics are updated with a penalty factor when the CRC check fails at the one or more checkpoints; the one or more path metrics are updated according to:

$${PM}_{i}^{L} = {\sum }_{j = 0}^{i} Ln ( 1 + {e}^{- ( 1 - 2 {â}_{j L} )} + 𝒻 ( CRC )$$

Where PM represents a path metric and represents the penalty factor; the one or more path metrics are compared against a threshold at each checkpoint, and wherein at least one decoding path with a metric meeting the threshold is pruned.

An NE (e.g., a base station) for wireless communication is described. The NE may be configured to, capable of, or operable to perform one or more operations as described herein. For example, the NE may be configured to, capable of, or operable to segment DCI into two or more DCI segments; append one or more CRC bits to each segment of the two or more DCI segments; interleave the appended segments of the DCI and encode the interleaved appended segments to generate a DCI polar codeword; and transmit the DCI polar codeword.

A processor (e.g., a standalone processor chipset, or a component of a NE) for wireless communication is described. The processor may be configured to, capable of, or operable to perform one or more operations as described herein. For example, the processor may be configured to, capable of, or operable to segment DCI into two or more DCI segments; append one or more CRC bits to each segment of the two or more DCI segments; interleave the appended segments of the DCI and encode the interleaved appended segments to generate a DCI polar codeword; and transmit the DCI polar codeword.

A method performed or performable by an NE (e.g., a base station) for wireless communication is described. The method may include segmenting DCI into two or more DCI segments; appending one or more CRC bits to each segment of the two or more DCI segments; interleaving the appended segments of the DCI and encoding the interleaved appended segments to generate a DCI polar codeword; and transmitting the DCI polar codeword.

In some implementations of the NE, the processor, and the method described herein, the CRC bits are distributed within the DCI segments using an interleaving pattern; the interleaving pattern generates one or more checkpoints within the DCI polar codeword by inserting one or more parity bits at each checkpoint; the one or more checkpoints represent information bits corresponding to bit channels a highest bit-channel reliability; the at least one processor is operable to cause the NE to: insert frozen bits into each segment of the two or more segments; a different portion of the one or more CRC bits is redistributed within the respective segment of the two or more segments; the two or more DCI segments are generated based at least in part on a defined polar sequence size.

### BRIEF DESCRIPTION OF THE DRAWINGS

FIG. 1 illustrates an example of a wireless communications system in accordance with aspects of the present disclosure.

FIG. 2 illustrates an example scenario for channel combining in accordance with one or more scenarios.

FIG. 3 illustrates an example of polarization effects in accordance with one or more scenarios.

FIG. 4 illustrates a decoding architecture in accordance with one or more implementations, and FIG. 5 illustrates a fast simplified successive cancellation (FSSC) decoding architecture.

FIG. 6 illustrates an example for inserting CRC bits in accordance with aspects of the present disclosure.

FIG. 7 illustrates a flowchart of a method in accordance with aspects of the present disclosure.

FIG. 8 illustrates a flowchart of a method in accordance with aspects of the present disclosure.

FIG. 9 illustrates an example of a UE in accordance with aspects of the present disclosure.

FIG. 10 illustrates an example of a processor in accordance with aspects of the present disclosure.

FIG. 11 illustrates an example of an NE in accordance with aspects of the present disclosure.

FIG. 12 illustrates a flowchart of a method in accordance with aspects of the present disclosure.

FIG. 13 illustrates a flowchart of a method in accordance with aspects of the present disclosure.

### DETAILED DESCRIPTION

In a wireless communications system, a UE and an NE (e.g., a base station, gNB) may support wireless communication (e.g., reception and/or transmission of wireless communication) using time-frequency resources. As part of using time-frequency resources, DCI may be transmitted by a NE over physical downlink control channel (PDCCH) to a UE to inform the UE of different operational parameters, such as how to access wireless resources, schedule transmissions, and apply power control. DCI may be encoded by the NE and subsequently decoded by a UE receiving transmission of the encoded DCI.

To detect potential errors in decoded DCI, CRC can be applied at a transmitter by appending a checksum to encoded DCI packets. A receiver that receives the encoded DCI packets can apply CRC check to the decoded DCI packets to assess potential errors in the received encoded DCI. Some wireless communication systems utilize distributed-CRC DCI where CRC bits are distributed throughout a codeword rather than appending them only at the end. This design enables early error detection, pruning of invalid decoding paths, and lower complexity in blind decoding of DCI. Leveraging these features, distributed CRC can enable early termination of decoding, which can conserve time, power, and processing resources. For example, improvement in blind-decoding early termination directly benefits the UE by reducing computational load and clock-cycle consumption. The blind decoding of control channels has been used in UE to extract signaling information in downlink without knowing the exact location of control channel elements (CCEs). To reduce the decoding complexity and latency, DCI decoding processes can be terminated if the UE is able to determine in the early decoding stages that the UE is not the intended receiver of the code block being checked. Further, early termination in PDCCH blind decoding, particularly path metric-assisted early termination, can significantly improve the observed false alarm rate (FAR). The FAR represents the probability that a corrupted packet passes the CRC check and is mistakenly accepted as valid. This is because the UE can terminate many decoding attempts by monitoring the path metric values within the SCL decoder without relying on CRC evaluations. This independent mechanism for filtering invalid candidates substantially reduces the FAR, as many invalid decoding paths are terminated early and never reach the CRC check stage.

Some systems for distributed CRC bits may lead to too few distributed CRC bits, which may reduce the effectiveness of early termination. In some systems, for example, only the first three CRC bits (the 141st, 142nd, and 143rd bits at the interleaver input) are actually distributed, providing only limited early-termination capability when the payload size is large. For a typical SCL polar decoder with a list size of 8, the probability that at least one of the eight decoding paths satisfies these three CRC checks is quite high. Consequently, UEs frequently decode the entire codeword even when a decoding failure is unavoidable, negating the intended benefits of early termination and reducing overall UE decoding efficiency. In addition, the distributed-CRC interleaver supports a maximum payload size of only 140 bits, further restricting its usefulness for 6G applications.

This disclosure presents solutions and procedures that enables early termination of polar decoding using path metrics updated based on CRC bits. CRC bits are interleaved and distributed within the information and frozen bits payload and are designed such as the path metrics of the unreliable paths are increased at different checkpoints. After path metrics reach a predefined threshold determined based on the universal polar sequence, an early-termination procedure is initiated. The proposed solution is independent of the DCI payload size; therefore, it is scalable and applicable for any information bits size within and beyond NR range.

Aspects of the present disclosure are described in the context of a wireless communications system and include implementations that provide for early termination of polar decoding using path metrics updated based on CRC bits. In implementations, CRC bits are interleaved and distributed within the information bits and frozen bits payload and are designed such that the path metrics of the unreliable decoding paths may be increased at different checkpoints. After path metrics reach a predefined threshold determined based on a polar sequence, an early termination procedure may be initiated. The proposed solutions are independent of the DCI payload size and are thus scalable and applicable for any information bits size.

For example, implementations provide for early termination of polar decoding using distributed CRC within the DCI payload to adjust path metrics at different checkpoints of the SCL/SSC decoder. The path metric values in the list can be used to detect a decoding failure in an early stage. When a suboptimal decoder is used for polar codes, the path metric values may not decrease as decoding steps proceed. Beyond a threshold (e.g., τ), unreliable decoding paths associated with high CRC adjusted path metrics may be discarded, and early termination may occur when multiple (e.g., all) decoding paths are discarded. By performing the described techniques, a device in a wireless communications system can reduce processing and network resources used for DCI decoding and increase accuracy in DCI decoding.

Reference is made herein to communicating data or information, such as signaling communication resources and/or communications that are transmitted or received between devices. It is to be appreciated that other terms may be used interchangeably with communicating, such as signaling, transmitting, receiving, outputting, forwarding, retrieving, obtaining, and so forth.

Aspects of the present disclosure are described in the context of a wireless communications system. Aspects of the present disclosure are further set forth in the accompanying drawings and the description below. The description set forth herein, in connection with the accompanying drawings, describes example implementations and does not represent all the implementations that may be implemented or that are within the scope of the claims. The detailed description includes specific details for the purpose of providing an understanding of the described implementations. These implementations, however, may be practiced without these specific details. Additionally, the description set forth herein, in connection with the accompanying drawings is provided to enable a person having ordinary skill in the art to make or use the present disclosure. Various modifications to the disclosure will be apparent to a person having ordinary skill in the art, and the generic principles defined herein may be applied to other variations without departing from the scope of the present disclosure. Thus, the present disclosure is not limited to the examples and implementations described herein but is to be accorded the broadest scope consistent with the principles and novel features disclosed herein.

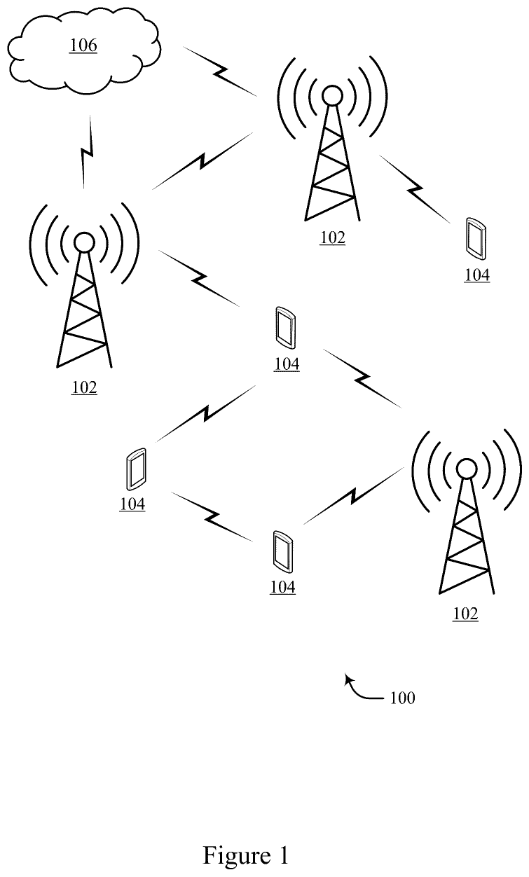

FIG. 1 illustrates an example of a wireless communications system 100 in accordance with aspects of the present disclosure. The wireless communications system 100 may include one or more NEs 102, one or more UEs 104, and a core network (CN) 106. The wireless communications system 100 may support various radio access technologies. In some implementations, the wireless communications system 100 may be a 4G network, such as an LTE network or an LTE-Advanced (LTE-A) network. In some other implementations, the wireless communications system 100 may be a NR network, such as a 5G network, a 5G-Advanced (5G-A) network, or a 5G ultrawideband (5G-UWB) network. In other implementations, the wireless communications system 100 may be a combination of a 4G network and a 5G network, or other suitable radio access technology including Institute of Electrical and Electronics Engineers (IEEE) 802.11 (Wi-Fi), IEEE 802.16 (WiMAX), IEEE 802.20. The wireless communications system 100 may support radio access technologies beyond 5G, for example, 6G. Additionally, the wireless communications system 100 may support technologies, such as time division multiple access (TDMA), frequency division multiple access (FDMA), or code division multiple access (CDMA), etc.

The one or more NEs 102 may be dispersed throughout a geographic region to form the wireless communications system 100. One or more of the NEs 102 described herein may be or include or may be referred to as a network node, a base station, an access point (AP), a network element, a network function, a network entity, a radio access network (RAN), a NodeB, an eNodeB (eNB), a next-generation NodeB (gNB), or other suitable terminology. An NE 102 and a UE 104 may communicate via a communication link, which may be a wireless or wired connection. For example, an NE 102 and a UE 104 may perform wireless communication (e.g., receive signaling, transmit signaling) over a Uu interface.

An NE 102 may provide a geographic coverage area for which the NE 102 may support services for one or more UEs 104 within the geographic coverage area. For example, an NE 102 and a UE 104 may support wireless communication of signals related to services (e.g., voice, video, packet data, messaging, broadcast, etc.) according to one or multiple radio access technologies. In some implementations, an NE 102 may be moveable, for example, a satellite associated with a non-terrestrial network (NTN). In some implementations, different geographic coverage areas associated with the same or different radio access technologies may overlap, but the different geographic coverage areas may be associated with different NE 102.

The one or more UEs 104 may be dispersed throughout a geographic region of the wireless communications system 100. A UE 104 may include or may be referred to as a remote unit, a mobile device, a wireless device, a remote device, a subscriber device, a transmitter device, a receiver device, or some other suitable terminology. In some implementations, the UE 104 may be referred to as a unit, a station, a terminal, or a client, among other examples. Additionally, or alternatively, the UE 104 may be referred to as an Internet-of-Things (IoT) device, an Internet-of-Everything (IoE) device, or machine-type communication (MTC) device, among other examples.

A UE 104 may be able to support wireless communication directly with other UEs 104 over a communication link. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link may be referred to as a sidelink. For example, a UE 104 may support wireless communication directly with another UE 104 over a PC5 interface.

An NE 102 may support communications with the CN 106, or with another NE 102, or both. For example, an NE 102 may interface with other NE 102 or the CN 106 through one or more backhaul links (e.g., S1, N2, N6, or other network interface). In some implementations, the NE 102 may communicate with each other directly. In some other implementations, the NE 102 may communicate with each other indirectly (e.g., via the CN 106). In some implementations, one or more NEs 102 may include subcomponents, such as an access network entity, which may be an example of an access node controller (ANC). An ANC may communicate with the one or more UEs 104 through one or more other access network transmission entities, which may be referred to as a radio heads, smart radio heads, or transmission-reception points (TRPs).

The CN 106 may support user authentication, access authorization, tracking, connectivity, and other access, routing, or mobility functions. The CN 106 may be an evolved packet core (EPC), or a 5G core (5GC), which may include a control plane entity that manages access and mobility (e.g., a mobility management entity (MME), an access and mobility management functions (AMF)) and a user plane entity that routes packets or interconnects to external networks (e.g., a serving gateway (S-GW), a packet data network (PDN) gateway (P-GW), or a user plane function (UPF)). In some implementations, the control plane entity may manage non-access stratum (NAS) functions, such as mobility, authentication, and bearer management (e.g., data bearers, signal bearers, etc.) for the one or more UEs 104 served by the one or more NEs 102 associated with the CN 106.

The CN 106 may communicate with a packet data network over one or more backhaul links (e.g., via an S1, N2, N6, or other network interface). The packet data network may include an application server. In some implementations, one or more UEs 104 may communicate with the application server. A UE 104 may establish a session (e.g., a protocol data unit (PDU) session, or the like) with the CN 106 via an NE 102. The CN 106 may route traffic (e.g., control information, data, and the like) between the UE 104 and the application server using the established session (e.g., the established PDU session). The PDU session may be an example of a logical connection between the UE 104 and the CN 106 (e.g., one or more network functions of the CN 106).

In the wireless communications system 100, the NEs 102 and the UEs 104 may use resources of the wireless communications system 100 (e.g., time resources (e.g., symbols, slots, subframes, frames, or the like) or frequency resources (e.g., subcarriers, carriers)) to perform various operations (e.g., wireless communications). In some implementations, the NEs 102 and the UEs 104 may support different resource structures. For example, the NEs 102 and the UEs 104 may support different frame structures. In some implementations, such as in 4G, the NEs 102 and the UEs 104 may support a single frame structure. In some other implementations, such as in 5G and among other suitable radio access technologies, the NEs 102 and the UEs 104 may support various frame structures (i.e., multiple frame structures). The NEs 102 and the UEs 104 may support various frame structures based on one or more numerologies.

One or more numerologies may be supported in the wireless communications system 100, and a numerology may include a subcarrier spacing and a cyclic prefix. A first numerology (e.g., μ=0) may be associated with a first subcarrier spacing (e.g., 15 kHz) and a normal cyclic prefix. In some implementations, the first numerology (e.g., μ=0) associated with the first subcarrier spacing (e.g., 15 kHz) may utilize one slot per subframe. A second numerology (e.g., μ=1) may be associated with a second subcarrier spacing (e.g., 30 kHz) and a normal cyclic prefix. A third numerology (e.g., μ=2) may be associated with a third subcarrier spacing (e.g., 60 kHz) and a normal cyclic prefix or an extended cyclic prefix. A fourth numerology (e.g., μ=3) may be associated with a fourth subcarrier spacing (e.g., 120 kHz) and a normal cyclic prefix. A fifth numerology (e.g., μ=4) may be associated with a fifth subcarrier spacing (e.g., 240 kHz) and a normal cyclic prefix.

A time interval of a resource (e.g., a communication resource) may be organized according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 ms duration. In some implementations, each frame may have the same duration. In some implementations, each subframe of a frame may have the same duration.

Additionally, or alternatively, a time interval of a resource (e.g., a communication resource) may be organized according to slots. For example, a subframe may include a number (e.g., quantity) of slots. The number of slots in each subframe may also depend on the one or more numerologies supported in the wireless communications system 100. For instance, the first, second, third, fourth, and fifth numerologies (i.e., μ=0, μ=1, μ=2, μ=3, μ=4) associated with respective subcarrier spacings of 15 kHz, 30 kHz, 60 kHz, 120 kHz, and 240 kHz may utilize a single slot per subframe, two slots per subframe, four slots per subframe, eight slots per subframe, and 16 slots per subframe, respectively. Each slot may include a number (e.g., quantity) of symbols (e.g., OFDM symbols). In some implementations, the number (e.g., quantity) of slots for a subframe may depend on a numerology. For a normal cyclic prefix, a slot may include 14 symbols. For an extended cyclic prefix (e.g., applicable for 60 kHz subcarrier spacing), a slot may include 12 symbols. The relationship between the number of symbols per slot, the number of slots per subframe, and the number of slots per frame for a normal cyclic prefix and an extended cyclic prefix may depend on a numerology. It should be understood that reference to a first numerology (e.g., μ=0) associated with a first subcarrier spacing (e.g., 15 kHz) may be used interchangeably between subframes and slots.

In the wireless communications system 100, an electromagnetic (EM) spectrum may be split, based on frequency or wavelength, into various classes, frequency bands, frequency channels, etc. By way of example, the wireless communications system 100 may support one or multiple operating frequency bands, such as frequency range designations FR1 (410 MHz-7.125 GHz), FR2 (24.25 GHz-52.6 GHz), FR3 (7.125 GHZ-24.25 GHz), FR4 (52.6 GHz-114.25 GHZ), FR4a or FR4-1 (52.6 GHz-71 GHZ), and FR5 (114.25 GHZ-300 GHz). In some implementations, the NEs 102 and the UEs 104 may perform wireless communications over one or more of the operating frequency bands. In some implementations, FR1 may be used by the NEs 102 and the UEs 104, among other equipment or devices for cellular communications traffic (e.g., control information, data). In some implementations, FR2 may be used by the NEs 102 and the UEs 104, among other equipment or devices for short-range, high data rate capabilities.

FR1 may be associated with one or multiple numerologies (e.g., at least three numerologies). For example, FR1 may be associated with a first numerology (e.g., μ=0), which includes 15 kHz subcarrier spacing; a second numerology (e.g., μ=1), which includes 30 kHz subcarrier spacing; and a third numerology (e.g., μ=2), which includes 60 kHz subcarrier spacing. FR2 may be associated with one or multiple numerologies (e.g., at least 2 numerologies). For example, FR2 may be associated with a third numerology (e.g., μ=2), which includes 60 kHz subcarrier spacing; and a fourth numerology (e.g., μ=3), which includes 120 kHz subcarrier spacing.

According to implementations, one or more of the NEs 102 and the UEs 104 are operable to implement various aspects of the techniques described with reference to the present disclosure. For example, a UE 104 receives a DCI polar codeword including CRC bits distributed at different checkpoints of the received DCI polar codeword. The UE 104 decodes at least a portion of the DCI polar codeword to generate multiple decoding paths and one or more path metrics for the decoding paths, and performs one or more CRC checks at one or more checkpoints of the decoding paths, where the one or more checkpoints include one or more CRC parity bits. The UE 104 updates one or more of the path metrics for one or more of the decoding paths based at least in part on an outcome of the one or more CRC checks.

An NE 102 (e.g., a base station, gNB) segments DCI into two or more DCI segments and appends one or more CRC bits to each segment of the two or more DCI segments. The NE 102 interleaves the appended segments of the DCI and encode the interleaved appended segments to generate a DCI polar codeword and transmits the DCI polar codeword.

Reference is made herein to communicating data or information, such as signaling communication resources and/or communications that are transmitted or received between devices. It is to be appreciated that other terms may be used interchangeably with communicating, such as signaling, transmitting, receiving, outputting, forwarding, retrieving, obtaining, and so forth.

With reference to DCI generation, information carried by the PDCCH may be referred to as DCI. DCI includes the scheduling information for the UL or DL data channels and other control information for one UE or a group of UEs. DCI undergoes a sequence of processing steps to incorporate the PDCCH payload. With QPSK modulation, a CCE may include 54 payload resource elements and can carry 108 bits. This may involve the output size of the rate matching block to be L·108, where L is the associated precoding aggregation level (AL). Based on the channel environment and available resources, a NE can adaptively choose a proper AL for a DCI to adjust the code rate. If the size of the DCI format is less than 12 bits, some zero padding bits may be appended until the payload size equals 12 bits. For the DCI payload bits, a 24-bit CRC is calculated and appended to the payload. The CRC allows a UE to detect the presence of errors in the decoded DCI payload bits. After the CRC is attached, the last 16 CRC bits are masked with the corresponding identifier, referred to as a radio network temporary identifier (RNTI). Using an RNTI mask, a UE can detect the DCI for its unicast data and distinguish sets of DCI with different purposes that have the same payload size. The CRC attached bits are then interleaved to distribute the CRC bits among the information bits. In some scenarios, an interleaver may support a maximum input size of 164 bits. In such scenarios, DCI without CRC can have at most 140 of payload bits. The bits are then encoded by the polar encoder to protect the DCI against errors during transmission. The encoder output is processed using a sub-block interleaver and then rate matched to fit the allocated payload REs of the DCI.

For control channels, a high priority may be considered the high reliability and the optimization for early termination to reduce complexity. In 5G NR, distributed CRC was designed to achieve both objectives, with a strong emphasis on reliability. In some scenarios, early termination can reduce blind detection complexity. For example, CRC bits can be interleaved to earlier positions so that SCL decoding can be early terminated as soon as all remaining paths fail a CRC check. Further, BLER/FAR may be balanced with early termination. Placing CRC or parity-check bits to an earlier position can increase early termination, but will negatively impact BLER and FAR.

Path metric-based early termination methods can be implemented without relying on distributed CRC or parity-check (PC) bits. The path metric inherently captures the reliability of each decoding path in SCL decoding, allowing the decoder to anticipate decoding failures at an early stage. A large path metric value indicates low path reliability; therefore, if all path metrics exceed a predefined threshold, the decoder can trigger early termination. Another approach uses the relative differences between path metrics. If all surviving paths have similar path metric values, this may indicate that none of them is clearly reliable enough to validate the final decoding decision, and early termination should be activated. The arrangement of the parity check bits may occur where the information block is divided into three parts and includes three parity check bits. When the SCL decoding process reaches the parity check bit, the parity check is applied to each of the candidate paths. The paths that pass the parity check are denoted as survived paths. If none of the survived paths pass the parity check of the parity check bit, then the decoding will be terminated.

Polar codes utilize the notion of channel polarization. In using polar codes, we write W: X→Y to denote a generic B-DMC with input alphabet X, output alphabet Y, and transition probabilities W (y|x), x∈X, y∈Y. The input alphabet X will be {0,1}, and the output alphabet and the transition probabilities may be arbitrary. We write W_{N} to denote the channel corresponding to N uses of W; thus, W_{N}: X_{N}→Y_{N} with

$${W}_{N} ( {y}_{1}^{N} \vert {x}_{1}^{N} ) = {Π}_{i = 1}^{N} W ( {y}_{i} \vert {x}_{i} ) .$$

Given a B-DMC W, there are two channel parameters of primary interest: (1) the symmetric capacity:

$$I ( W ) = {\sum }_{y ∈ Y} {\sum }_{x ∈ X} \frac{1}{2} W ( y \vert x ) log ( \frac{W ( y \vert x )}{\frac{1}{2} W ( y \vert 0 ) + \frac{1}{2} W ( y \vert 1 )} )$$

and (2) the Bhattacharyya parameter:

$$Z ( W ) = Δ {\sum }_{y ∈ Y} \sqrt{W ( y \vert 0 ) W ( y \vert 1 )}$$

These parameters are used as measures of rate and reliability, respectively. I(W) is the highest rate at which reliable communication is possible across W using the inputs of W with equal frequency. Z(W) is an upper bound on the probability of maximum-likelihood (ML) decision error when W is used only once to transmit a 0 or 1. Z (W) may take the values in [0, 1], whereby a 0 indicates a null probability of error in ML-sense, and respectively, a 1 indicates a certain probability of error in ML-sense.

Channel polarization is an operation by which N independent copies are generated of a given B-DMC W, a second set of N channels

$$\{ {W}_{N}^{( i )} : 1 \leq i \leq N \}$$

that show a polarization effect in the sense that, as N becomes large, the symmetric capacity terms

$$\{ I ( {W}_{N}^{( i )} ) \}$$

tend towards 0 or 1 for most but a vanishing fraction of indices i. This operation consists of a channel combining phase and a channel splitting phase.

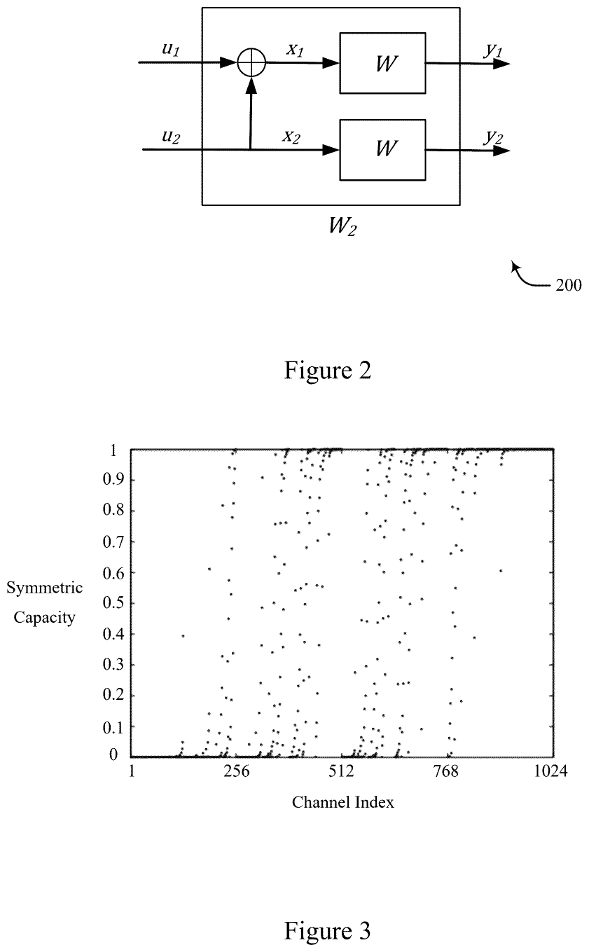

FIG. 2 illustrates an example scenario 200 for channel combining in accordance with one or more scenarios. Channel combining combines copies of a given B-DMC W in a recursive manner to produce a vector channel W_{N}: X_{N}→Y_{N}, where N can be any power of two, N=2ⁿ, n≥0. The recursion begins at the 0-th level (n=0) with only one copy of W and we set W₁≙W. The first level (n=1) of the recursion combines two independent copies of W₁ as shown in the scenario 200 and obtains the channel W₂: X₂→Y₂ with the transition probabilities:

$$( {y}_{1} , {y}_{2} \vert {u}_{1} , {u}_{2} ) = W ( {y}_{1} \vert {u}_{1} ⊕ {u}_{2} ) W ( {y}_{2} \vert {u}_{2} )$$

Regarding channel splitting, having synthesized the vector channel W_{N} out of W^{N}, the next step of channel polarization is to split W_{N} back into a set of N binary-input coordinate channels

$${W}_{N}^{( i )} : X \to {Y}^{N} \times {X}^{i - 1} , 1 \leq i \leq N ,$$

defined by the transition probabilities:

$${W}_{N}^{( i )} ( {y}_{1}^{N} , {u}_{1}^{i - 1} \vert {u}_{i} ) {=}^{Δ} {\sum }_{{u}_{i + 1}^{N} ∈ {X}^{N - i}} \frac{1}{{2}^{N - 1}} {W}_{N} ( {y}_{1}^{N} \vert {u}_{1}^{N} )$$

where

$$( {y}_{1}^{N} , {u}_{1}^{i - 1} )$$

denotes the output of

$${W}_{N}^{( i )}$$

and uᵢ its input. To gain an intuitive understanding of the channels

$$\{ {W}_{N}^{( i )} \} ,$$

consider a genie-aided successive cancellation decoder in which the ith decision element estimates uᵢ after observing

$${y}_{1}^{N}$$

and the past channel inputs

$${u}_{1}^{i - 1}$$

(supplied correctly by the genie regardless of any decision errors at earlier stages). If

$${u}_{1}^{N}$$

its a-priori uniform on X^{N}, then

$${W}_{N}^{( i )}$$

is the effective channel indicated by the i^{th} decision element in this scenario.

In some scenarios for a B-DMC W, the channels

$$\{ {W}_{N}^{( i )} \}$$

polarize in the sense that, for any fixed δ∈(0, 1), as N goes to infinity through powers of two, the fraction of indices i∈{1, . . . , N} for which

$$I ( {W}_{N}^{( i )} ) ∈ ( 1 - δ , 1 ]$$

goes to I(W) and the fraction for which

$$I ( {W}_{N}^{( i )} ) ∈ [ 0 , δ )$$

goes to 1−I(W). These polarization effects are illustrated in FIG. 3.

Regarding encoding schemes, let

$$F = [ \begin{matrix}1 & 0 \\ 1 & 1\end{matrix} ] ,$$

F^{⊗n} is a N×N matrix known as the Kernel or the polar base matrix, where N=2ⁿ, ⊗n denotes n-th Kronecker power, and F^{⊗n}=F⊗F^{⊗(n-1)}. Let the n-bit binary representation of integer i be bₙ₋₁, bₙ₋₂, . . . b₀. The n-bit representation b₀, b₁, . . . , bₙ is a bit-reversal order of i. The generator matrix of polar code is defined as G_{N}=B_{N}F^{⊗n}, where B_{N} is a bit-reversal permutation matrix. The polar code is generated by:

$${x}_{1}^{N} = {u}_{1}^{N} {G}_{N} = {u}_{1}^{N} {B}_{N} {F}^{⊗ n}$$

### Where

$${x}_{1}^{N} = ( {x}_{1} , {x}_{2} , … , {x}_{N} )$$

is the encoded bit sequence, and

$${u}_{1}^{N} = ( {u}_{1} , {u}_{2} , … , {u}_{N} )$$

is the encoding bit sequence. The bit indexes of

$${u}_{1}^{N}$$

are divided into two subsets: the one containing the information bits and the other containing the frozen bits. For simplicity, the frozen bits are set “0”.

One aspect of polar codes encoding is the splitting of data sequence indexes into two different sets before transmission. The first set includes the indexes of the data to be transmitted on the noise-free channels. The other set includes the indexes corresponding to the known frozen bits to be transmitted on the pure-noise channel. One technique for polar codes encoding is based on Bhattacharyya parameter bounds. Another technique uses a Monte-Carlo estimation approach that could be used to construct polar codes; however, this approach may have higher complexity than the other techniques. Another proposed technique for polar codes encoding is known as a density evolution technique. This technique approximates the exact transition probability of each binary input channel to overcome difficulties in calculating the actual values of the Bhattacharyya parameter. Recently, a Gaussian approximation technique has been proposed to construct polar codes. This technique estimates a bit channel metric inversely proportional to a defined Q-function, which represents its bit error rate (BER) under Gaussian approximation.

Regarding polar codes construction based on the Bhattacharyya parameter bounds, a generalized upper and lower bound of Bhattacharyya parameter are determined. The upper bound of this parameter corresponds to the noisiest channel, while its lower bound corresponds to the lowest noisy channel. Thus, for better performance, the gap between the Bhattacharyya parameter extremes may be increased. This increases the polarization of the synthetic channels carrying the information bits. Then, the most appropriate kernel matrix associated with Bhattacharyya parameter constraints may be selected.

Techniques have been introduced for decoding polar codes, including successive cancellation (SC), successive cancellation list (SCL) and log-likelihood ratio (LLR) based SCL. As SC decoding may be sub-optimal for finite length polar codes, SCL decoding was introduced achieving the maximum likelihood bound for a sufficiently large list size, at the cost of increased complexity due to the list decoding nature. Further enhancement of the code may be conducted via concatenating a high-rate outer code such as CRC and parity check PC codes. Iterative decoding of polar codes based on message passing over the encoding graph has been possible through BP decoders. A belief propagation list (BPL) decoder has been proposed with comparable performance to the SCL decoder of polar codes, which already achieves the maximum likelihood (ML) bound of polar codes for sufficiently large list size L.

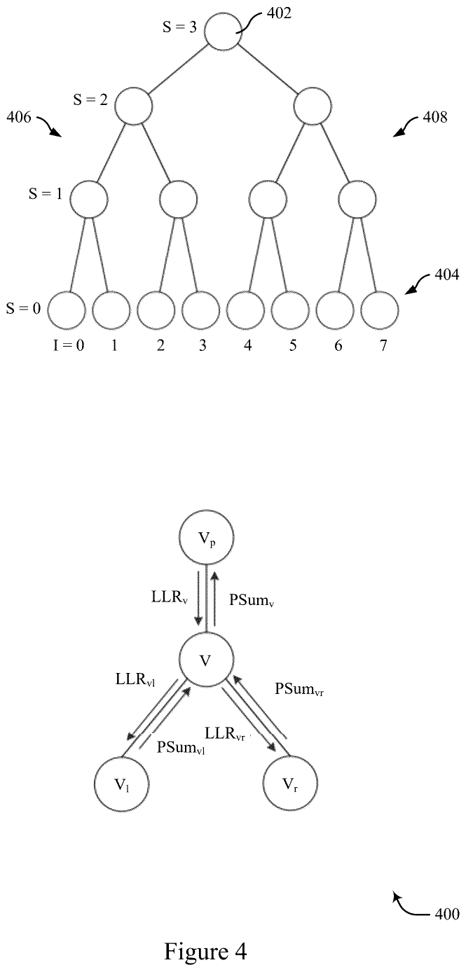

FIG. 4 illustrates a decoding architecture 400 in accordance with one or more implementations, and FIG. 5 illustrates a fast simplified successive cancellation (FSSC) decoding architecture 500. The decoding architecture 400 illustrates decoding using a binary tree traversal with each subtree therein representing a shorter polar code. The binary tree search process starts from a root node 402 to leaf nodes 404 and from a left branch 406 to a right branch 408. At the p-th (0≤p≤n) level of the decoding tree, each parent node referred as

$${𝒩}_{i}^{p} ,$$

has a left child node

$${𝒩}_{2 i - 1}^{p - 1}$$

and a right child node

$${𝒩}_{2 i}^{p - 1} ,$$

where 1≤i≤2n−p. There are two types of messages, e.g., the soft LLRs

$${α}_{i}^{p} [ 1 : 2 p ]$$

that are propagated from the parent node to their child nodes, and the hard codeword

$${β}_{i}^{p} [ 1 : 2 p ]$$

that is propagated from the child nodes to their parent node in return. The original SC decoding algorithm traverses the tree by visiting all the nodes and edges, leading to high decoding latency. Simplified SC decoders can fast decode certain subtrees (shorter polar codes) and thus “prune” those subtrees. The resulting decoding latency is largely determined by the number of remaining edges and nodes in the pruned binary tree.

The FSSC decoding algorithm can be simplified for some nodes with special information and frozen bit patterns. In particular, four types of special nodes, e.g., Rate-0, Rate-1, REP, and SPC, are considered in the FSSC decoder, and their structures are described as follows: Rate-0: all bits are frozen bits, c={0, 0, . . . , 0}; Rate-1: all bits are information bits, c={1, 1, . . . , 1}; REP: all bits are frozen bits except the rightmost one, c={0, . . . , 0, 1}; SPC: all bits are information bits except the leftmost one, c={0, 1, . . . , 1}.

In aspects of this disclosure, implementations are described for early termination of polar decoding using distributed CRC within the DCI payload in order to adjust path metrics at different checkpoints of a decoder, e.g., a SCL/SSC decoder. The path metric values in the list can be used to detect a decoding failure in an early stage. When a suboptimal decoder is used for polar codes, the path metric values may not decrease as decoding steps proceed. In implementations, the path metric values rapidly increase when a received signal is corrupted. Beyond a threshold t, the unreliable paths associated with high CRC adjusted path metrics can be discarded and early termination occurs when all paths are discarded. Different checkpoints can be designed to update the path metrics at an early stage of the decoding process such that PDCCH blind decoding complexity may be reduced without impacting the false alarm rate (FAR) and thus, the overall system performance. The described implementations may be valid for any DCI payload size and may be implemented with any CRC-aided decoder including successive cancellation list, simplified SC (SSC), partitioned list decoding (PSCL), etc.

Implementations include distributed CRC and path metric updates associated with early termination. In at least one implementation, a DCI payload of size K_{b} is first segmented into two or more segments I_{seg} according to a predefined segmentation rule. A CRC may be appended to each of the segments without prior interleaving of the CRC sequence. A further step of the encoding chain is an interleaver and frozen bits insertion block that outputs a sequence of length (K_{b}+K_{F}+K_{CRC}) before encoding the resulting sequence using a polar encoder.

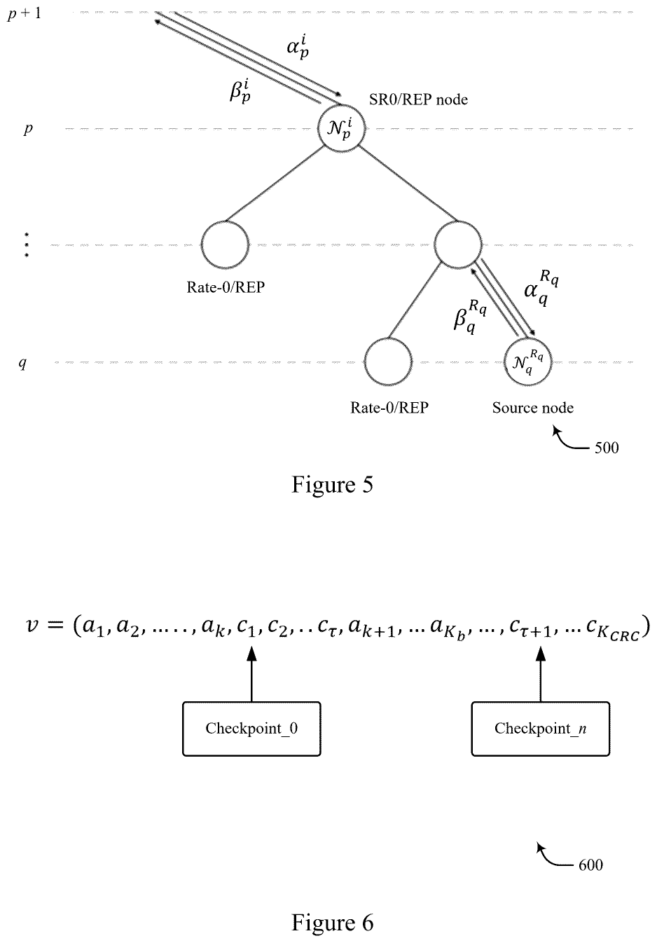

FIG. 6 illustrates an example 600 for inserting CRC bits in accordance with aspects of the present disclosure. In the example 600, the CRC bits c are distributed among encoded bits a such as at the decoder, and multiple checkpoints checkpoint_0, . . . checkpoint_n are set to update the path metrics based on the CRC check. In one implementation, a portion τ of the CRC bits (c₁, c₂, . . . c_{τ}) can be inserted at position k of the DCI payload such as the resulting information and parity bits could be represented. At each checkpoint, the CRC check can be calculated as:

$${tmp}_{i} = {a}_{0} ⊕ {a}_{1} ⊕ … ⊕ {a}_{k}$$

If tmpᵢ=cᵢ then the CRC passes; Else, the CRC fails.

In implementations, with the value of τ representing the number of CRC bits at each checkpoint, the number of the checkpoints could be determined and configured by the network to balance between the false alarm rate and power saving/early termination. In such implementations, CRC checking can be performed on a bit-by-bit basis for each CRC bit (e.g., rather than using the entire length-K_{CRC} vector as in some approaches). This bit-level checking allows the decoder to stop decoding earlier whenever any decoded CRC bit is found to be inconsistent with the decoded information bits on which it depends, across all candidate paths in the list. Moreover, the CRC check can be carried out during SCL decoding itself, unlike some methods that perform CRC verification only after SCL decoding has fully completed.

In implementations, the checkpoints may correspond to specific information bits positions determined based on the polar sequence. For example, the most reliable bit-channels carrying information bits may serve as checkpoints in addition to the CRC bits. In such implementations, more checkpoints could be set at early decoding stages which allows enhanced early termination schemes and increased energy efficiency.

In implementations, at each checkpoint the CRC bits are used to check the integrity of the subset of decoded information bits. In such implementations, the checksum may result in two different path metric updates at checkpoint [symbol] : (1) The CRC check passes, and the path metric

$${PM}_{i}^{L}$$

remains the same and the decoding continue to the next checkpoint; (2) The CRC fails, and the path metric

$${PM}_{i}^{L}$$

is increased by a penalty factor dependent on the CRC:

$${PM}_{i}^{L} = LLR ( i ) + \text{?} ( CRC )$$

$${PM}_{i}^{L} = {\sum }_{j = 0}^{i} Ln ( 1 + {e}^{- ( 1 - 2 {\hat{a}}_{jL} )} + \text{?} ( CRC )$$

In implementations, decoding paths with path metrics that exceed a predefined threshold p are pruned and the decoding continues with decoding the remaining paths. At each checkpoint, the path with the lowest path metric may be CRC checked, if the CRC passes, the decoding terminates and outputs the decoded bits. One implementations is based on the difference between the path metric value corresponding to individual paths. If all the paths have similar path metric values, this may indicate that none of the paths can be used to confirm the final decoding results, and early termination is to be triggered.

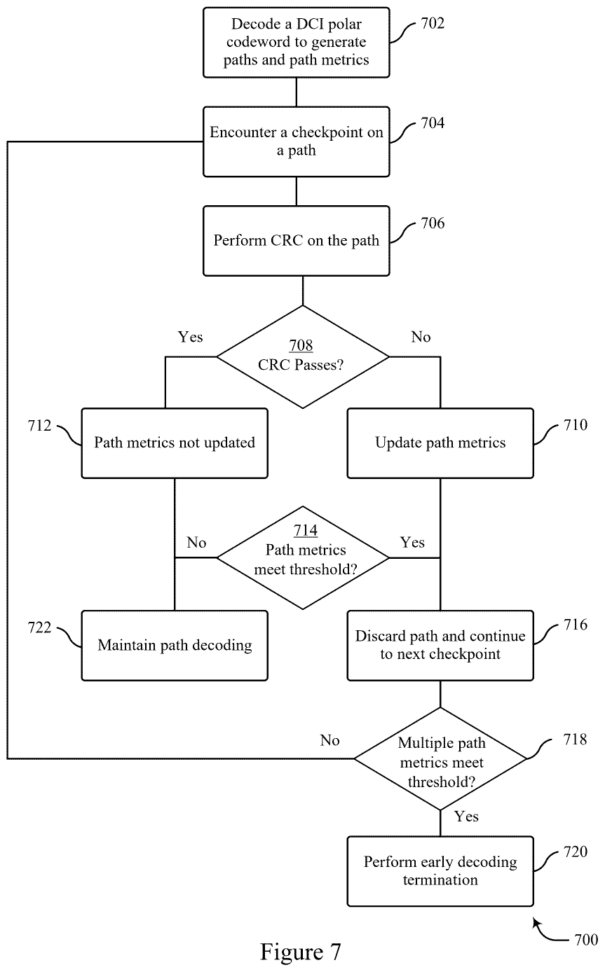

FIG. 7 illustrates a flowchart of a method 700 in accordance with aspects of the present disclosure. The operations of the method may be implemented by a UE as described herein. In some implementations, the UE may execute a set of instructions to control the function elements of the UE to perform the described functions. It should be noted that the method described herein describes a possible implementation, and that the operations and the steps may be rearranged or otherwise modified and that other implementations are possible.

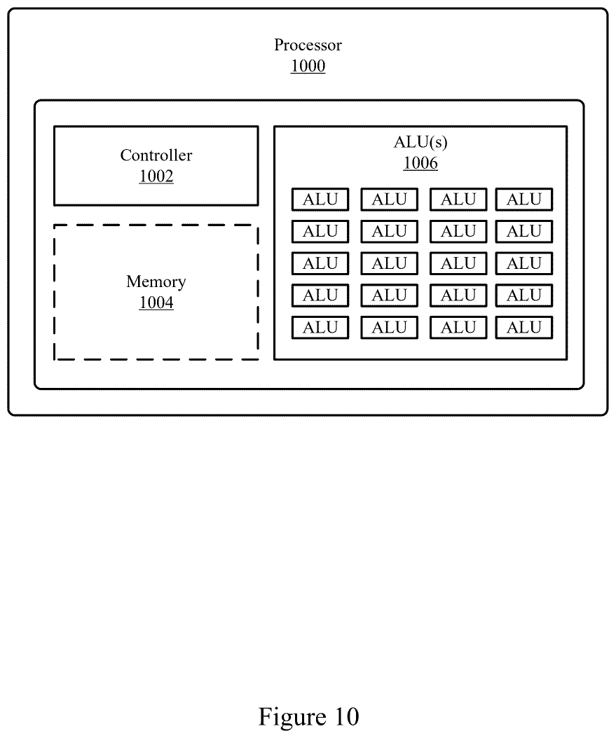

At 702, the method may include decoding a DCI polar codeword to generate paths and path metrics. The decoding, for example, generates different decoding paths and path metrics for each of the decoding paths. The operations of 702 may be performed in accordance with examples as described herein. In some implementations, aspects of the operations of 702 may be performed by a UE as described with reference to FIG. 10. At 704, the method may include encountering a checkpoint on a path. The checkpoint, for example, represents a parity bit that is specified to initiate a CRC check. The operations of 704 may be performed in accordance with examples as described herein. In some implementations, aspects of the operations of 704 may be performed by a UE as described with reference to FIG. 10.

At 706, the method may include performing CRC on the path. The CRC, for example, may be performed on decoded bits on the path up to the encountered checkpoint. The operations of 706 may be performed in accordance with examples as described herein. In some implementations, aspects of the operations of 706 may be performed by a UE as described with reference to FIG. 10. At 708, the method may include determining whether the CRC passes. The operations of 708 may be performed in accordance with examples as described herein. In some implementations, aspects of the operations of 708 may be performed by a UE as described with reference to FIG. 10. If the CRC does not pass (“No”), at 710 the method may include updating one or more path metrics. Updating the one or more path metrics, for example, includes applying a penalty value to the one or more path metrics. The operations of 710 may be performed in accordance with examples as described herein. In some implementations, aspects of the operations of 710 may be performed by a UE as described with reference to FIG. 10.

If the CRC does pass (“Yes”), at 712 the method may include not updating the one or more path metrics. The operations of 712 may be performed in accordance with examples as described herein. In some implementations, aspects of the operations of 712 may be performed by a UE as described with reference to FIG. 10. At 714, the method may include determining whether the one or more path metrics meet a threshold. The threshold, for example, represents a predefined path metric threshold value. The operations of 714 may be performed in accordance with examples as described herein. In some implementations, aspects of the operations of 714 may be performed by a UE as described with reference to FIG. 10.

If the one or more path metrics meet the threshold (“Yes”), at 716 the method may include discarding one or more paths (e.g., decoding paths) and continuing to a next decoding checkpoint. The operations of 716 may be performed in accordance with examples as described herein. In some implementations, aspects of the operations of 716 may be performed by a UE as described with reference to FIG. 10.

At 718, the method may include determining whether multiple path metrics (e.g., all path metrics) meet the threshold. The operations of 718 may be performed in accordance with examples as described herein. In some implementations, aspects of the operations of 718 may be performed by a UE as described with reference to FIG. 10. If multiple path metrics meet the threshold (“Yes”), at 720 the method may include performing early decoding termination. The operations of 720 may be performed in accordance with examples as described herein. In some implementations, aspects of the operations of 720 may be performed by a UE as described with reference to FIG. 10. If at 718 multiple path metrics do not meet the threshold (“No”), at 722 the method may include maintaining path decoding and the method may proceed to 704. The operations of 722 may be performed in accordance with examples as described herein. In some implementations, aspects of the operations of 722 may be performed by a UE as described with reference to FIG. 10.

In implementations, the paths with path metrics that exceed a predefined threshold ρ are pruned and decoding only continues decoding the remaining paths. At each checkpoint, the path with the lowest path metric may be CRC checked, if the CRC passes the decoding terminates and outputs the decoded bits. Some implementations may be based on the difference between the path metric value corresponding to individual paths. If all the paths have a similar path metric value, this may indicate that none of the paths can be used to confirm the final decoding results, and early termination is to be triggered.

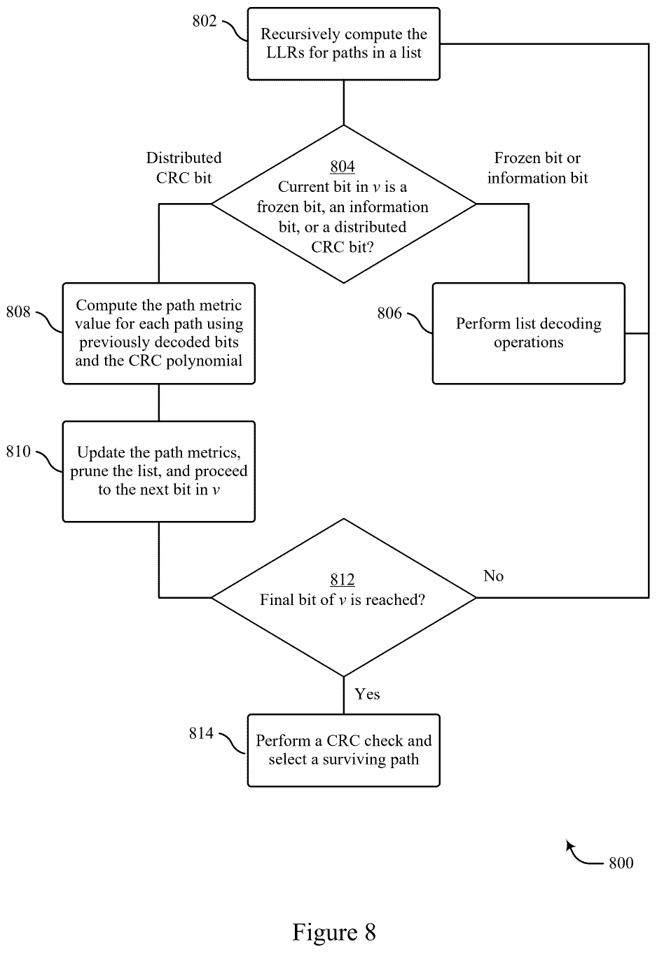

FIG. 8 illustrates a flowchart of a method 800 in accordance with aspects of the present disclosure. The operations of the method may be implemented by a UE as described herein. In some implementations, the UE may execute a set of instructions to control the function elements of the UE to perform the described functions. It should be noted that the method described herein describes a possible implementation, and that the operations and the steps may be rearranged or otherwise modified and that other implementations are possible. In implementations, a receiver may run in parallel L decoding paths and a remaining decoding path (e.g., surviving path) may be a path which passes the CRC check with the best path metric. Tree-pruning-style list decoding may be described with reference to the method 800.

At 802, the method may include recursively computing the LLRs for paths in a list. The operations of 802 may be performed in accordance with examples as described herein. In some implementations, aspects of the operations of 802 may be performed by a UE as described with reference to FIG. 10. At 804, the method may include determining whether the current bit in v is a frozen bit, an information bit, or a distributed CRC bit. The operations of 804 may be performed in accordance with examples as described herein. In some implementations, aspects of the operations of 804 may be performed by a UE as described with reference to FIG. 10.

If the current bit in v is either a frozen bit or an information bit, at 806 the method may include performing list-decoding operations (e.g., standard list decoding operations). The operations of 806 may be performed in accordance with examples as described herein. In some implementations, aspects of the operations of 806 may be performed by a UE as described with reference to FIG. 10. The method 800 may then proceed to 802. If the current bit in v is a distributed CRC bit, at 808 the method may include computing the path metric value for each path using previously decoded bits and the CRC polynomial. The operations of 808 may be performed in accordance with examples as described herein. In some implementations, aspects of the operations of 808 may be performed by a UE as described with reference to FIG. 10. At 810, the method may include updating the path metrics, pruning the list, and proceeding to the next bit in v. The operations of 810 may be performed in accordance with examples as described herein. In some implementations, aspects of the operations of 810 may be performed by a UE as described with reference to FIG. 10.

At 812, the method may include determining whether a final bit of v is reached. The operations of 812 may be performed in accordance with examples as described herein. In some implementations, aspects of the operations of 812 may be performed by a UE as described with reference to FIG. 10. If the final bit of v is reached (“Yes”), at 814 the method may include performing a CRC check and selecting a surviving path. The surviving path, for example, represents a decoding path indicated as being accurately decoded. The operations of 814 may be performed in accordance with examples as described herein. In some implementations, aspects of the operations of 814 may be performed by a UE as described with reference to FIG. 10. If the final bit of v is not reached (“No”), the method 800 may proceed to 802. In implementations, step 806 may assign an infinitely large penalty to a path whose CRC bit is inconsistent, and step 810 acts as the tree-pruning operation, implicitly eliminating paths whose computed CRC bit do not match the corresponding LLR value.

In implementations, the CRC matrix G (defined below) may be interleaved such as discussed herein. In such scenarios, one interleaving pattern π, independent of the payload size, may be defined and stored in the encoder and decoder memories. The interleaving pattern π enables the permutations of the rows/columns of G as follows:

$$G = ( \begin{matrix}1 & ⋯ & 0 & {g}_{0 , 0} & ⋯ & {g}_{0 , k - 1} \\ ⋮ & ⋱ & ⋮ & ⋮ & ⋱ & ⋮ \\ 0 & ⋯ & 1 & {g}_{n - 1 , 0} & ⋯ & {g}_{n - 1 , k - 1}\end{matrix} )$$

Due to the successive decoding of Polar code, if all the related information bits are decoded at some decoding stage, the error check of the CRC bit is possible. For SCL based decoding (e.g., CA-SCL or PC-Polar), at each decoding stage, there may be at most L branches kept. Therefore, if all these L branches fail for the CRC check of the available CRC bits, there may be some errors in the codeword, either in information bits or in the CRC bits, and which may not be corrected during subsequent decoding if not terminated. Hence, the decoding may terminate. This may reduce device power and calculations used for decoding.

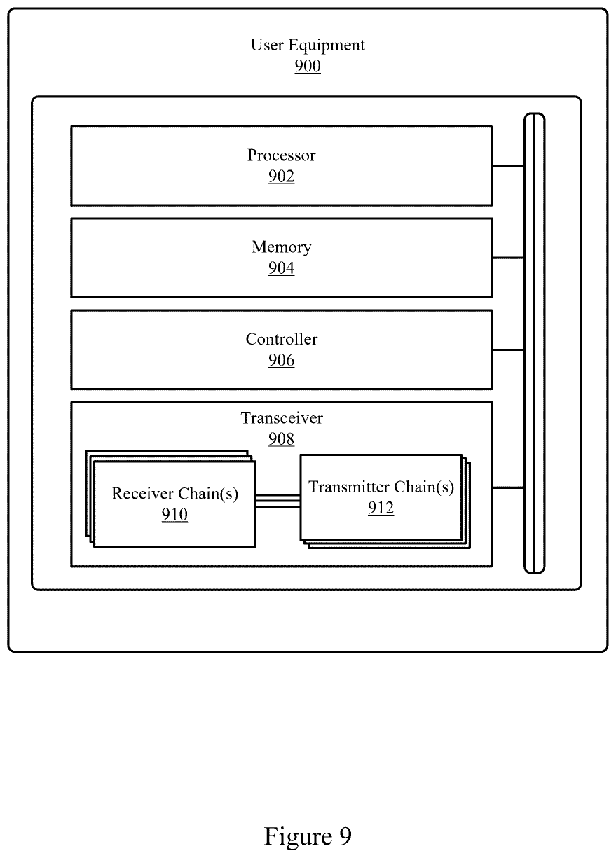

FIG. 9 illustrates an example of a UE 900 in accordance with aspects of the present disclosure. The UE 900 may include a processor 902, a memory 904, a controller 906, and a transceiver 908. The processor 902, the memory 904, the controller 906, or the transceiver 908, or various combinations thereof or various components thereof may be examples of means for performing various aspects of the present disclosure as described herein. These components may be coupled (e.g., operatively, communicatively, functionally, electronically, electrically) via one or more interfaces.

The processor 902, the memory 904, the controller 906, or the transceiver 908, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 902 may include an intelligent hardware device (e.g., a general-purpose processor, a DSP, a CPU, an ASIC, an FPGA, or any combination thereof). In some implementations, the processor 902 may be configured to operate the memory 904. In some other implementations, the memory 904 may be integrated into the processor 902. The processor 902 may be configured to execute computer-readable instructions stored in the memory 904 to cause the UE 900 to perform various functions of the present disclosure.

The memory 904 may include volatile or non-volatile memory. The memory 904 may store computer-readable, computer-executable code including instructions when executed by the processor 902 cause the UE 900 to perform various functions described herein. The code may be stored in a non-transitory computer-readable medium such as the memory 904 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 902 and the memory 904 coupled with the processor 902 may be configured to cause the UE 900 to perform one or more of the functions described herein (e.g., executing, by the processor 902, instructions stored in the memory 904). For example, the processor 902 may support wireless communication at the UE 900 in accordance with examples as disclosed herein. The UE 900 may be configured to or operable to support a means for receiving a DCI polar codeword including CRC bits distributed at different checkpoints of the received DCI polar codeword; decoding at least a portion of the DCI polar codeword to generate multiple decoding paths and one or more path metrics for the decoding paths; performing one or more CRC checks at one or more checkpoints of the decoding paths, wherein the one or more checkpoints include one or more CRC parity bits; and updating one or more of the path metrics for one or more of the decoding paths based at least in part on an outcome of the one or more CRC checks.

Additionally, the UE 900 may be configured to support any one or combination of where the DCI polar codeword is decoded using one or more sequential list decoders, and wherein the one or more path metrics are updated between frozen bits and information bits of the one or more decoding paths; the sequential list decoder includes one or more of a successive cancellation list (SCL), a SSCL, or a pruning successive cancellation list (PSCL); further comprising triggering early termination of decoding of the DCI polar codeword based at least in part on a one or more path metrics meeting a threshold; the UE includes a decoder operable to perform the early termination of decoding of the DCI polar codeword; further comprising continuing the decoding of the DCI polar codeword based at least in part on one or more path metrics being below the threshold; the threshold is determined based at least in part on a universal polar reliability sequence and is independent of channel condition and code rate; the one or more path metrics indicate a reliability of respective individual decoding paths; the one or more path metrics are updated with a penalty factor when the CRC check fails at the one or more checkpoints; the one or more path metrics are updated according to:

$${PM}_{i}^{L} = {\sum }_{j = 0}^{i} Ln ( 1 + {e}^{- ( 1 - 2 {\hat{a}}_{jL} )} + \text{?} ( CRC ) ;$$

where PM represents a path metric and represents the penalty factor; the one or more path metrics are compared against a threshold at each checkpoint, and wherein at least one decoding path with a metric meeting the threshold is pruned.

Additionally, or alternatively, the UE 900 may support at least one memory (e.g., the memory 904) and at least one processor (e.g., the processor 902) coupled with the at least one memory and configured to cause the UE to receive a DCI polar codeword including CRC bits distributed at different checkpoints of the received DCI polar codeword; decode at least a portion of the DCI polar codeword to generate multiple decoding paths and one or more path metrics for the decoding paths; perform one or more CRC checks at one or more checkpoints of the decoding paths, wherein the one or more checkpoints include one or more CRC parity bits; and update one or more of the path metrics for one or more of the decoding paths based at least in part on an outcome of the one or more CRC checks.

Additionally, the UE 900 may be configured to support any one or combination of where the DCI polar codeword is decoded using one or more sequential list decoders, and wherein the one or more path metrics are updated between frozen bits and information bits of the one or more decoding paths; the sequential list decoder includes one or more of a successive cancellation list (SCL), a SSCL, or a pruning successive cancellation list (PSCL); the at least one processor is operable to cause the UE to: trigger early termination of decoding of the DCI polar codeword based at least in part on a one or more path metrics meeting a threshold; the UE includes a decoder operable to perform the early termination of decoding of the DCI polar codeword; the at least one processor is operable to cause the UE to: continue the decoding of the DCI polar codeword based at least in part on one or more path metrics being below the threshold; the threshold is determined based at least in part on a universal polar reliability sequence and is independent of channel condition and code rate; the one or more path metrics indicate a reliability of respective individual decoding paths; the one or more path metrics are updated with a penalty factor when the CRC check fails at the one or more checkpoints; the one or more path metrics are updated according to: where PM represents a path metric and represents the penalty factor; the one or more path metrics are compared against a threshold at each checkpoint, and wherein at least one decoding path with a metric meeting the threshold is pruned.

The controller 906 may manage input and output signals for the UE 900. The controller 906 may also manage peripherals not integrated into the UE 900. In some implementations, the controller 906 may utilize an operating system such as iOS®, ANDROID®, WINDOWS®, or other operating systems. In some implementations, the controller 906 may be implemented as part of the processor 902.

In some implementations, the UE 900 may include at least one transceiver 908. In some other implementations, the UE 900 may have more than one transceiver 908. The transceiver 908 may represent a wireless transceiver. The transceiver 908 may include one or more receiver chains 910, one or more transmitter chains 912, or a combination thereof.

A receiver chain 910 may be configured to receive signals (e.g., control information, data, packets) over a wireless medium. For example, the receiver chain 910 may include one or more antennas to receive a signal over the air or wireless medium. The receiver chain 910 may include at least one amplifier (e.g., a low-noise amplifier (LNA)) configured to amplify the received signal. The receiver chain 910 may include at least one demodulator configured to demodulate the receive signal and obtain the transmitted data by reversing the modulation technique applied during transmission of the signal. The receiver chain 910 may include at least one decoder for decoding the demodulated signal to receive the transmitted data.

A transmitter chain 912 may be configured to generate and transmit signals (e.g., control information, data, packets). The transmitter chain 912 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 912 may also include at least one power amplifier configured to amplify the modulated signal to an appropriate power level suitable for transmission over the wireless medium. The transmitter chain 912 may also include one or more antennas for transmitting the amplified signal into the air or wireless medium.

FIG. 10 illustrates an example of a processor 1000 in accordance with aspects of the present disclosure. The processor 1000 may be an example of a processor configured to perform various operations in accordance with examples as described herein. The processor 1000 may include a controller 1002 configured to perform various operations in accordance with examples as described herein. The processor 1000 may optionally include at least one memory 1004, which may be, for example, an L1/L2/L3 cache. Additionally, or alternatively, the processor 1000 may optionally include one or more arithmetic-logic units (ALUs) 1006. One or more of these components may be in electronic communication or otherwise coupled (e.g., operatively, communicatively, functionally, electronically, electrically) via one or more interfaces (e.g., buses).

The processor 1000 may be a processor chipset and include a protocol stack (e.g., a software stack) executed by the processor chipset to perform various operations (e.g., receiving, obtaining, retrieving, transmitting, outputting, forwarding, storing, determining, identifying, accessing, writing, reading) in accordance with examples as described herein. The processor chipset may include one or more cores, one or more caches (e.g., memory local to or included in the processor chipset (e.g., the processor 1000) or other memory (e.g., random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), and others).

The controller 1002 may be configured to manage and coordinate various operations (e.g., signaling, receiving, obtaining, retrieving, transmitting, outputting, forwarding, storing, determining, identifying, accessing, writing, reading) of the processor 1000 to cause the processor 1000 to support various operations in accordance with examples as described herein. For example, the controller 1002 may operate as a control unit of the processor 1000, generating control signals that manage the operation of various components of the processor 1000. These control signals include enabling or disabling functional units, selecting data paths, initiating memory access, and coordinating timing of operations.

The controller 1002 may be configured to fetch (e.g., obtain, retrieve, receive) instructions from the memory 1004 and determine subsequent instruction(s) to be executed to cause the processor 1000 to support various operations in accordance with examples as described herein. The controller 1002 may be configured to track memory addresses of instructions associated with the memory 1004. The controller 1002 may be configured to decode instructions to determine the operation to be performed and the operands involved. For example, the controller 1002 may be configured to interpret the instruction and determine control signals to be output to other components of the processor 1000 to cause the processor 1000 to support various operations in accordance with examples as described herein. Additionally, or alternatively, the controller 1002 may be configured to manage flow of data within the processor 1000. The controller 1002 may be configured to control transfer of data between registers, ALUs 1006, and other functional units of the processor 1000.

The memory 1004 may include one or more caches (e.g., memory local to or included in the processor 1000 or other memory, such as RAM, ROM, DRAM, SDRAM, SRAM, MRAM, flash memory, etc. In some implementations, the memory 1004 may reside within or on a processor chipset (e.g., local to the processor 1000). In some other implementations, the memory 1004 may reside external to the processor chipset (e.g., remote to the processor 1000).

The memory 1004 may store computer-readable, computer-executable code including instructions that, when executed by the processor 1000, cause the processor 1000 to perform various functions described herein. The code may be stored in a non-transitory computer-readable medium such as system memory or another type of memory. The controller 1002 and/or the processor 1000 may be configured to execute computer-readable instructions stored in the memory 1004 to cause the processor 1000 to perform various functions. For example, the processor 1000 and/or the controller 1002 may be coupled with or to the memory 1004, the processor 1000, and the controller 1002, and may be configured to perform various functions described herein. In some examples, the processor 1000 may include multiple processors and the memory 1004 may include multiple memories. One or more of the multiple processors may be coupled with one or more of the multiple memories, which may, individually or collectively, be configured to perform various functions herein.

The one or more ALUs 1006 may be configured to support various operations in accordance with examples as described herein. In some implementations, the one or more ALUs 1006 may reside within or on a processor chipset (e.g., the processor 1000). In some other implementations, the one or more ALUs 1006 may reside external to the processor chipset (e.g., the processor 1000). One or more ALUs 1006 may perform one or more computations such as addition, subtraction, multiplication, and division on data. For example, one or more ALUs 1006 may receive input operands and an operation code, which determines an operation to be executed. One or more ALUs 1006 may be configured with a variety of logical and arithmetic circuits, including adders, subtractors, shifters, and logic gates, to process and manipulate the data according to the operation. Additionally, or alternatively, the one or more ALUs 1006 may support logical operations such as AND, OR, exclusive-OR (XOR), not-OR (NOR), and not-AND (NAND), enabling the one or more ALUs 1006 to handle conditional operations, comparisons, and bitwise operations.

The processor 1000 may support wireless communication in accordance with examples as disclosed herein. The processor 1000 may be configured to or operable to support at least one controller (e.g., the controller 1002) coupled with at least one memory (e.g., the memory 1004) and configured to cause the processor to receive a DCI polar codeword including CRC bits distributed at different checkpoints of the received DCI polar codeword; decode at least a portion of the DCI polar codeword to generate multiple decoding paths and one or more path metrics for the decoding paths; perform one or more CRC checks at one or more checkpoints of the decoding paths, wherein the one or more checkpoints include one or more CRC parity bits; and update one or more of the path metrics for one or more of the decoding paths based at least in part on an outcome of the one or more CRC checks.

Additionally, the processor 1000 may be configured to or operable to support any one or combination of where the DCI polar codeword is decoded using one or more sequential list decoders, and wherein the one or more path metrics are updated between frozen bits and information bits of the one or more decoding paths; the sequential list decoder includes one or more of a successive cancellation list (SCL), a SSCL, or a pruning successive cancellation list (PSCL); the at least one processor is operable to cause the UE to: trigger early termination of decoding of the DCI polar codeword based at least in part on a one or more path metrics meeting a threshold; the UE includes a decoder operable to perform the early termination of decoding of the DCI polar codeword; the at least one processor is operable to cause the UE to: continue the decoding of the DCI polar codeword based at least in part on one or more path metrics being below the threshold; the threshold is determined based at least in part on a universal polar reliability sequence and is independent of channel condition and code rate; the one or more path metrics indicate a reliability of respective individual decoding paths; the one or more path metrics are updated with a penalty factor when the CRC check fails at the one or more checkpoints; the one or more path metrics are updated according to: where PM represents a path metric and represents the penalty factor; the one or more path metrics are compared against a threshold at each checkpoint, and wherein at least one decoding path with a metric meeting the threshold is pruned.

The processor 1000 may support wireless communication in accordance with examples as disclosed herein. The processor 1000 may be configured to or operable to support at least one controller (e.g., the controller 1002) coupled with at least one memory (e.g., the memory 1004) and configured to cause the processor to segment DCI into two or more DCI segments; append one or more CRC bits to each segment of the two or more DCI segments; interleave the appended segments of the DCI and encode the interleaved appended segments to generate a DCI polar codeword; and transmit the DCI polar codeword.

Additionally, the processor 1000 may be configured to or operable to support any one or combination of where the CRC bits are distributed within the DCI segments using an interleaving pattern; the interleaving pattern generates one or more checkpoints within the DCI polar codeword by inserting a parity bit at each checkpoint; the one or more checkpoints represent information bits corresponding to bit channels a highest estimated reliability; the at least one processor is operable to cause the NE to: insert frozen bits into each segment of the two or more segments; a different portion of the one or more CRC bits is appended to each respective segment of the two or more segments; the two or more DCI segments are generated based at least in part on a defined polar sequence size.

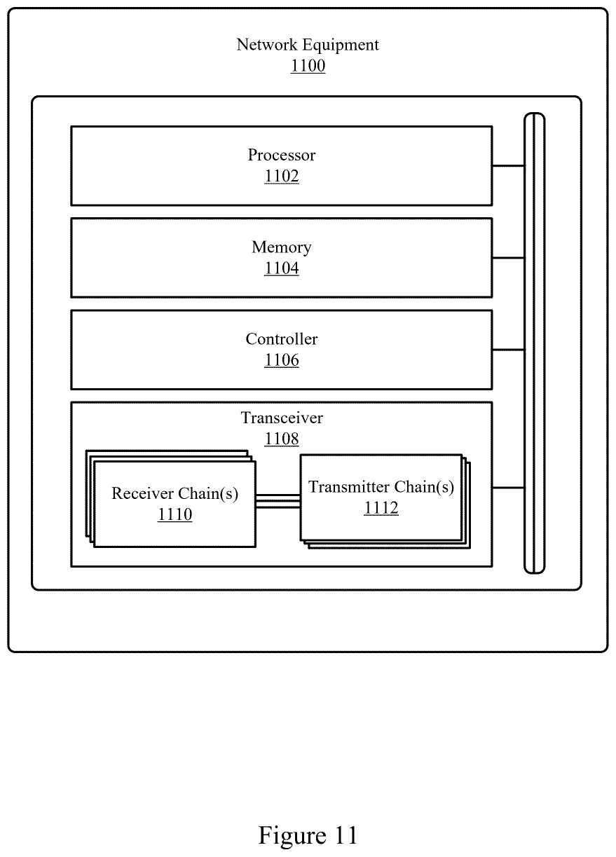

FIG. 11 illustrates an example of an NE 1100 in accordance with aspects of the present disclosure. The NE 1100 may include a processor 1102, a memory 1104, a controller 1106, and a transceiver 1108. The processor 1102, the memory 1104, the controller 1106, or the transceiver 1108, or various combinations thereof or various components thereof may be examples of means for performing various aspects of the present disclosure as described herein. These components may be coupled (e.g., operatively, communicatively, functionally, electronically, electrically) via one or more interfaces.

The processor 1102, the memory 1104, the controller 1106, or the transceiver 1108, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 1102 may include an intelligent hardware device (e.g., a general-purpose processor, a DSP, a CPU, an ASIC, an FPGA, or any combination thereof). In some implementations, the processor 1102 may be configured to operate the memory 1104. In some other implementations, the memory 1104 may be integrated into the processor 1102. The processor 1102 may be configured to execute computer-readable instructions stored in the memory 1104 to cause the NE 1100 to perform various functions of the present disclosure.

The memory 1104 may include volatile or non-volatile memory. The memory 1104 may store computer-readable, computer-executable code including instructions when executed by the processor 1102 cause the NE 1100 to perform various functions described herein. The code may be stored in a non-transitory computer-readable medium such as the memory 1104 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 1102 and the memory 1104 coupled with the processor 1102 may be configured to cause the NE 1100 to perform one or more of the functions described herein (e.g., executing, by the processor 1102, instructions stored in the memory 1104). For example, the processor 1102 may support wireless communication at the NE 1100 in accordance with examples as disclosed herein. The NE 1100 may be configured to or operable to support a means for segmenting DCI into two or more DCI segments; appending one or more CRC bits to each segment of the two or more DCI segments; interleaving the appended segments of the DCI and encode the interleaved appended segments to generate a DCI polar codeword; and transmitting the DCI polar codeword.

Additionally, the NE 1100 may be configured to or operable to support any one or combination of where the CRC bits are distributed within the DCI segments using an interleaving pattern; the interleaving pattern generates one or more checkpoints within the DCI polar codeword by inserting a parity bit at each checkpoint; the one or more checkpoints represent information bits corresponding to bit channels a highest estimated reliability; inserting frozen bits into each segment of the two or more segments; a different portion of the one or more CRC bits is appended to each respective segment of the two or more segments; the two or more DCI segments are generated based at least in part on a defined polar sequence size.

Additionally, or alternatively, the NE 1100 may support at least one memory (e.g., the memory 1104) and at least one processor (e.g., the processor 1102) coupled with the at least one memory and configured to cause the NE to segment DCI into two or more DCI segments; append one or more CRC bits to each segment of the two or more DCI segments; interleave the appended segments of the DCI and encode the interleaved appended segments to generate a DCI polar codeword; and transmit the DCI polar codeword.

Additionally, the NE 1100 may be configured to support any one or combination of where the CRC bits are distributed within the DCI segments using an interleaving pattern; the interleaving pattern generates one or more checkpoints within the DCI polar codeword by inserting a parity bit at each checkpoint; the one or more checkpoints represent information bits corresponding to bit channels a highest estimated reliability; the at least one processor is operable to cause the NE to: insert frozen bits into each segment of the two or more segments; a different portion of the one or more CRC bits is appended to each respective segment of the two or more segments; the two or more DCI segments are generated based at least in part on a defined polar sequence size.

The controller 1106 may manage input and output signals for the NE 1100. The controller 1106 may also manage peripherals not integrated into the NE 1100. In some implementations, the controller 1106 may utilize an operating system such as iOS®, ANDROID®, WINDOWS®, or other operating systems. In some implementations, the controller 1106 may be implemented as part of the processor 1102.

In some implementations, the NE 1100 may include at least one transceiver 1108. In some other implementations, the NE 1100 may have more than one transceiver 1108. The transceiver 1108 may represent a wireless transceiver. The transceiver 1108 may include one or more receiver chains 1110, one or more transmitter chains 1112, or a combination thereof.

A receiver chain 1110 may be configured to receive signals (e.g., control information, data, packets) over a wireless medium. For example, the receiver chain 1110 may include one or more antennas to receive a signal over the air or wireless medium. The receiver chain 1110 may include at least one amplifier (e.g., a low-noise amplifier (LNA)) configured to amplify the received signal. The receiver chain 1110 may include at least one demodulator configured to demodulate the receive signal and obtain the transmitted data by reversing the modulation technique applied during transmission of the signal. The receiver chain 1110 may include at least one decoder for decoding the demodulated signal to receive the transmitted data.

A transmitter chain 1112 may be configured to generate and transmit signals (e.g., control information, data, packets). The transmitter chain 1112 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 1112 may also include at least one power amplifier configured to amplify the modulated signal to an appropriate power level suitable for transmission over the wireless medium. The transmitter chain 1112 may also include one or more antennas for transmitting the amplified signal into the air or wireless medium.

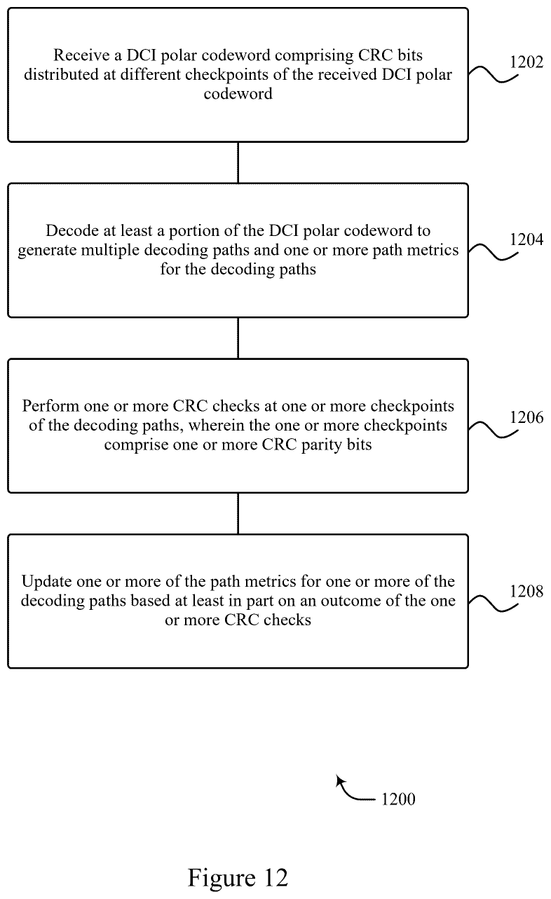

FIG. 12 illustrates a flowchart of a method 1200 in accordance with aspects of the present disclosure. The operations of the method may be implemented by a UE as described herein. In some implementations, the UE may execute a set of instructions to control the function elements of the UE to perform the described functions. It should be noted that the method described herein describes a possible implementation, and that the operations and the steps may be rearranged or otherwise modified and that other implementations are possible.

At 1202, the method may include receiving a DCI polar codeword comprising CRC bits distributed at different checkpoints of the received DCI polar codeword. The operations of 1202 may be performed in accordance with examples as described herein. In some implementations, aspects of the operations of 1202 may be performed by a UE as described with reference to FIG. 9.

At 1204, the method may include decoding at least a portion of the DCI polar codeword to generate multiple decoding paths and one or more path metrics for the decoding paths. The operations of 1204 may be performed in accordance with examples as described herein. In some implementations, aspects of the operations of 1204 may be performed by a UE as described with reference to FIG. 9.

At 1206, the method may include performing one or more CRC checks at one or more checkpoints of the decoding paths, wherein the one or more checkpoints comprise one or more CRC parity bits. The operations of 1206 may be performed in accordance with examples as described herein. In some implementations, aspects of the operations of 1206 may be performed a UE as described with reference to FIG. 9.

At 1208, the method may include updating one or more of the path metrics for one or more of the decoding paths based at least in part on an outcome of the one or more CRC checks. The operations of 1208 may be performed in accordance with examples as described herein. In some implementations, aspects of the operations of 1208 may be performed a UE as described with reference to FIG. 9.

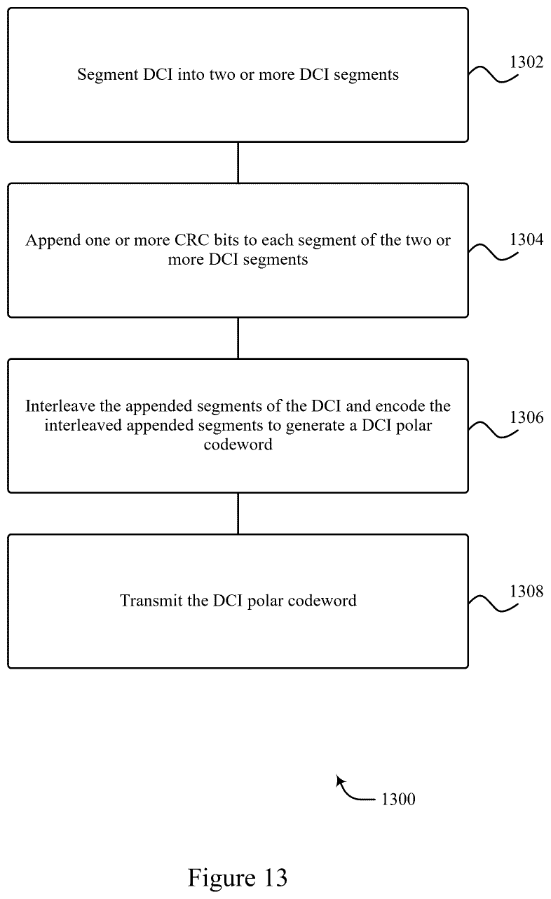

FIG. 13 illustrates a flowchart of a method 1300 in accordance with aspects of the present disclosure. The operations of the method may be implemented by an NE as described herein. In some implementations, the NE may execute a set of instructions to control the function elements of the NE to perform the described functions. It should be noted that the method described herein describes a possible implementation, and that the operations and the steps may be rearranged or otherwise modified and that other implementations are possible.

At 1302, the method may include segmenting DCI into two or more DCI segments. The operations of 1302 may be performed in accordance with examples as described herein. In some implementations, aspects of the operations of 1302 may be performed by an NE as described with reference to FIG. 11.

At 1304, the method may include appending one or more CRC bits to each segment of the two or more DCI segments. The operations of 1304 may be performed in accordance with examples as described herein. In some implementations, aspects of the operations of 1304 may be performed by an NE as described with reference to FIG. 11.

At 1306, the method may include interleaving the appended segments of the DCI and encoding the interleaved appended segments to generate a DCI polar codeword. The operations of 1306 may be performed in accordance with examples as described herein. In some implementations, aspects of the operations of 1306 may be performed an NE as described with reference to FIG. 11.

At 1308, the method may include transmitting the DCI polar codeword. The operations of 1308 may be performed in accordance with examples as described herein. In some implementations, aspects of the operations of 1308 may be performed an NE as described with reference to FIG. 11.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE) for wireless communication, comprising:
at least one memory; and
at least one processor coupled with the at least one memory and operable to cause the UE to:
receive a downlink control information (DCI) polar codeword comprising cyclic redundancy check (CRC) bits distributed at different checkpoints of the received DCI polar codeword;
decode at least a portion of the DCI polar codeword to generate multiple decoding paths and one or more path metrics for the decoding paths;
perform one or more CRC checks at one or more checkpoints of the decoding paths, wherein the one or more checkpoints comprise one or more CRC parity bits; and
update one or more of the path metrics for one or more of the decoding paths based at least in part on an outcome of the one or more CRC checks.

2. The UE of claim 1, wherein the DCI polar codeword is decoded using one or more sequential list decoders, and wherein the one or more path metrics are updated between frozen bits and information bits of the one or more decoding paths.

3. The UE of claim 2, wherein the sequential list decoder comprises one or more of a successive cancellation list (SCL), a simplified successive cancellation list (SSCL), or a pruning successive cancellation list (PSCL).

4. The UE of claim 1, wherein the at least one processor is operable to cause the UE to:
trigger early termination of decoding of the DCI polar codeword based at least in part on a one or more path metrics meeting a threshold.

5. The UE of claim 4, wherein the UE comprises a decoder operable to perform the early termination of decoding of the DCI polar codeword.

6. The UE of claim 4, wherein the at least one processor is operable to cause the UE to:
continue the decoding of the DCI polar codeword based at least in part on one or more path metrics being below the threshold.

7. The UE of claim 4, wherein the threshold is determined based at least in part on a universal polar reliability sequence and is independent of channel condition and code rate.

8. The UE of claim 1, wherein the one or more path metrics indicate a reliability of respective individual decoding paths.

9. The UE of claim 1, wherein the one or more path metrics are updated with a penalty factor when the CRC check fails at the one or more checkpoints.

10. The UE of claim 9, wherein the one or more path metrics are updated according to:
$${PM}_{i}^{L} = {\sum }_{j = 0}^{i} Ln ( 1 + {e}^{- ( 1 - 2 {\hat{a}}_{jL} )} + \text{?} ( CRC )$$
where PM represents a path metric and [symbol] (CRC) represents the penalty factor.

11. The UE of claim 1, wherein the one or more path metrics are compared against a threshold at each checkpoint, and wherein at least one decoding path with a metric meeting the threshold is pruned.

12. A network equipment (NE) for wireless communication, comprising:
at least one memory; and
at least one processor coupled with the at least one memory and operable to cause the NE to:
segment downlink control information (DCI) into two or more DCI segments;
append one or more cyclic redundancy check (CRC) bits to each segment of the two or more DCI segments;
interleave the appended segments of the DCI and encode the interleaved appended segments to generate a DCI polar codeword; and
transmit the DCI polar codeword.

13. The NE of claim 12, wherein the CRC bits are distributed within the DCI segments using an interleaving pattern.

14. The NE of claim 13, wherein the interleaving pattern generates one or more checkpoints within the DCI polar codeword by inserting a parity bit at each checkpoint.

15. The NE of claim 14, wherein the one or more checkpoints represent information bits corresponding to bit channels a highest estimated reliability.

16. The NE of claim 12, wherein the at least one processor is operable to cause the NE to:
insert frozen bits into each segment of the two or more segments.

17. The NE of claim 12, wherein a different portion of the one or more CRC bits is appended to each respective segment of the two or more segments.

18. The NE of claim 12, wherein the two or more DCI segments are generated based at least in part on a defined polar sequence size.

19. A method performed by a user equipment (UE), the method comprising:
receiving a downlink control information (DCI) polar codeword comprising cyclic redundancy check (CRC) bits distributed at different checkpoints of the received DCI polar codeword;
decoding at least a portion of the DCI polar codeword to generate multiple decoding paths and one or more path metrics for the decoding paths;
performing one or more CRC checks at one or more checkpoints of the decoding paths, wherein the one or more checkpoints comprise one or more CRC parity bits; and
updating one or more of the path metrics for one or more of the decoding paths based at least in part on an outcome of the one or more CRC checks.

20. A method performed by a network equipment (NE), the method comprising:
segmenting downlink control information (DCI) into two or more DCI segments;
appending one or more cyclic redundancy check (CRC) bits to each segment of the two or more DCI segments;
interleaving the appended segments of the DCI and encoding the interleaved appended segments to generate a DCI polar codeword; and
transmitting the DCI polar codeword.
